(19) United States
(12) Patent Application Publication
(10) Pub. No.: US 2009/0296936 A1
(43) Pub. Date: Dec. 3, 2009

(54) SYSTEM AND METHOD FOR CREATING A SECURE BILLING IDENTITY FOR AN END USER USING AN IDENTITY ASSOCIATION

(75) Inventors: Milton Lie, Plano, TX (US); Brian Forbes, Plano, TX (US); Robert Burke, Dallas, TX (US)

Correspondence Address: FULBRIGHT & JAWORSKI L.L.P, 2200 ROSS AVENUE, SUITE 2800, DALLAS, TX, 75201-2784, US

(73) Assignee: Contineo Systems, Plano, TX (US)

(21) Appl. No.: 12/129,823

(22) Filed: May 30, 2008

(51) Int. Cl. H04L 9/14

(52) U.S. Cl. 380/277

(57) ABSTRACT

A system and method include a device connectable to a private network and designed to access to a public network, the device used to control identity associations for end user devices in the private network, wherein the device has an associated device key and is operable to receive additional keys associated with service providers, and a conditional access system associated with the device, the conditional access system operated by a key authority to manage the device key and to authenticate the service provider keys thereby allowing identity associations between the private network and the service providers.

### TECHNICAL FIELD

The present invention relates to broadband data networks, and more specifically to systems and methods for implementing an enhanced conditional access system (CAS) in a network environment using identity associations between users and providers.

### BACKGROUND OF THE INVENTION

A typical system 100 for providing broadband network access to a home network 109 is shown with regard to FIG. 1. In such a broadband network, a home 101 is usually connected to the broadband network 102 by means of a portal 103, such as a cable modem, fiber optic connection such as gigabit passive optical network (GPON), or a digital subscriber line (DSL) modem. The high speed modem typically has a single internet protocol (IP) address associated with it. The IP address may be fixed or may be dynamically allocated by the internet service provider (ISP). In addition to wireline portals, such as the cable or DSL modems, wireless or cellular portals such as WiMax, or femto or pico cell devices may be used to provide the connectivity between the home 101 and the broadband network 102.

Though there is a single IP address associated with the portal 103, there are often multiple devices connecting to broadband network 102 through portal 103. In such a home network, private addressing schemes are used with network address translation (NAT) provided by the portal or a router connected to the portal. In such a private addressing scheme the portal or router assigns a private address to each device connected to the network and then provides the translation between the private address used on the private side of the portal and the public address used to communicate with broadband network 102. The private addresses are usually dynamically assigned by the portal or router as devices are added and removed from the home network.

The topology of home networks, such as the one shown in FIG. 1, make it difficult to establish trusted connections with the end user devices, such as computer 104 or 105, or wireless devices 106, 107 or 108, due at least in part to the use of private addressing schemes within the private network. The use of physical tokens can help to overcome this difficulty and can enhance security by providing a mechanism for creating identity associations. The use of identity associations (a secure explicit path through an untrusted network with an established identity) for devices in the end user network would allow carriers and providers to establish a trusted link into the home network. Identity associations utilize key exchanges between a user and a content provider that allow for the creation of a digital supply chain in the network and for secure transactions between users and providers of content or services.

One type of trusted connection between a provider and user is the conditional access system (CAS) used by cable television providers. Traditional broadcast television is open access, meaning that anyone with an antenna can access the content of the broadcast television stations. The broadcasters have no control over the content once it is broadcast and must rely upon surveying and statistical analysis to determine who is watching their broadcasts. From a user perspective, while not requiring special access to view the content, the user must watch the content on their television at the appointed broadcast time.

Cable and Satellite television providers utilize conditional access systems to control access to their broadcasts to paying subscribers. Cable television broadcasts are encrypted or scrambled and only those subscribers with the proper descrambling hardware or software from the cable provider can access the content. In traditional CAS implementations, the only requirement for access is the payment of the subscriber fee. Cable providers are able to monitor their broadcasts through the monitoring of their subscriber base. Users of CAS broadcasts may be able to time shift the broadcasts through the use of digital video recorders, but the broadcasts must be watched on the television with the access hardware, such as a cable box.

Current CAS implementations are limited to pay-for-access and are able only to know the details of their subscriber base and not what an individual subscriber is watching/doing with their broadcasts. What is needed is a system and method that are able to use identity associations to manage access and to generate content detail records on users usage of the content and services.

### BRIEF SUMMARY OF THE INVENTION

In certain embodiments, the present invention is directed to a system including a device connectable to a private network and designed for access to a public network, the device used to control identity associations for end user devices in the private network, wherein the device has an associated device key and is operable to receive additional keys associated with service providers. The system further includes a conditional access system associated with the device, the conditional access system operated by a key authority to manage the device key and to authenticate the service provider keys thereby allowing identity associations between the private network and the service providers. In other embodiments a method of providing conditional access to content and services using an identity association which includes providing a device and associated device key to an end user, the device operable to establish identity associations between the user and service providers, the identity associations used to provide conditional access to content and services, issuing a service keys to the user on behalf of service providers to allow the service provider to establish an identity association with the user, and authenticating at a key authority the service provider keys on behalf of the service provider to allow the service provider to initiate a identity association with the user.

In other embodiments, the present invention is directed to a system for allowing an end user to access content across multiple platforms, where the system includes a home security gateway connectable to a private network and designed for access to a public network, the home security gateway used to control identity associations for end user devices in the private network, wherein the home security gateway has an associated device key and is operable to receive additional keys associated with service providers. The system further includes a conditional access system associated with the device, the conditional access system operated by a key authority to manage the device key and to authenticate the service provider keys thereby allowing identity associations between the private network and the service providers, and a device having access to the public network, the device able to recognize keys associated with the private network such that the device can access the private network using an identity association, wherein a proxy in the private network is able to maintain functional state for content viewed by the end user such that the end user is able to switch content access between the private network and the device while maintaining the functional state of the content.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating an existing home network topology;

FIG. 2 is a block diagram illustrating an embodiment of a system for providing secure, trusted communication between devices in a private network and a core network of a service provider according to the concepts described herein;

FIG. 3 is an embodiment of a diagram illustrating the relationships between keys in a conditional access system using identity associations;

FIG. 4 is a block diagram illustrating an embodiment of a conditional access system used to manage secure identity associations between a service provider and end user; and

FIG. 5 is a block diagram illustrating an embodiment of a conditional access system that allows for the storing of functional state for user's content or services.

### DETAILED DESCRIPTION OF THE INVENTION

In the current state of broadband networks, including the Internet, the network is split into distinct domains which, at the boundaries where they intersect, do include the necessary security protocols to allow simple secure transactions between the domains. For example, a user in a home or small business network may desire to pay for the services or content provided by a third party service provider. In order to get that content, the content must travel from the provider's network over an access network, and possibly a public internet, to a carrier network, and to the user's network and device, again possibly using an access network and a public internet. For a single transaction, the user may be able to establish an account with a user name and password and may provide credit card information to access the content. Unfortunately, since only a user name and password is used these types of transactions are not as secure as could be achieved by using a physical security token by the user. Further these transactions are done on a single transaction basis, where the user must log into their account for every transaction.

What is missing from current broadband networking is a digital supply chain which links the user, carrier and provider. The digital supply chain would use an identity association to provide a secure explicit path through the individual networks (including the provider network, the carrier network, the public network and the user's network) and an authorized relationship and billing agreement between the user and the provider and/or carrier. An identity association, as used herein, refers to a unique token on the user's side of the network and an entry in a provider database corresponding to the token. In the concepts described herein, the token is preferably a physical token such as a smart card or other identifying device issued by a provider that can be used by a user to create an association between the user and the provider. The identity association then allows for derived services between the user and the provider. Such derived services can include allowing the user and provider to establish a security association between the provider's network and the user's device or network. A security association as is understood in the art is a connection between end points that uses security information shared between the end points to support secured communication.

The identity association can also be used to allow other derived services, such as establish billing relationships and to enable other services between the user and provider or providing device access or content access in a trusted domain. Using the identity association the digital supply chain can be established allowing carriers and providers to provide such secure content and services to an end user to establish billing arrangements with the user that do not require separate authentication and credit card entry for each transaction. Examples of a digital supply chain are described in U.S. patent application Ser. No. 12/025,128, filed Feb. 4, 2008, and entitled SYSTEM AND METHOD FOR PROVIDING IDENTITY ASSOCIATIONS and in U.S. patent application Ser. No. 12/055,135 filed Mar. 25, 2008, and entitled SYSTEM AND METHOD FOR PRE-PLACING SECURE CONTENT ON AN END USER STORAGE DEVICE.

The identity associations and digital supply chain can also be used to create a new type of conditional access system, which will be referred to in accordance with the concepts described herein as iCAS. iCAS can use more than just subscriber or payment information to control access to particular content or services. With iCAS as described herein, identity associations can be used to both control access to content and to shift access to content by time, location, media, device or any other type of paradigm. Further, iCAS allows for the creation of content detail records (iCDRs) similar to the content detail records used by telephone companies. Providers using iCAS as described herein can identify content and services consumed on a per identity association basis such that usage or consumption of content can be tracked without need to resort to survey or statistical analysis.

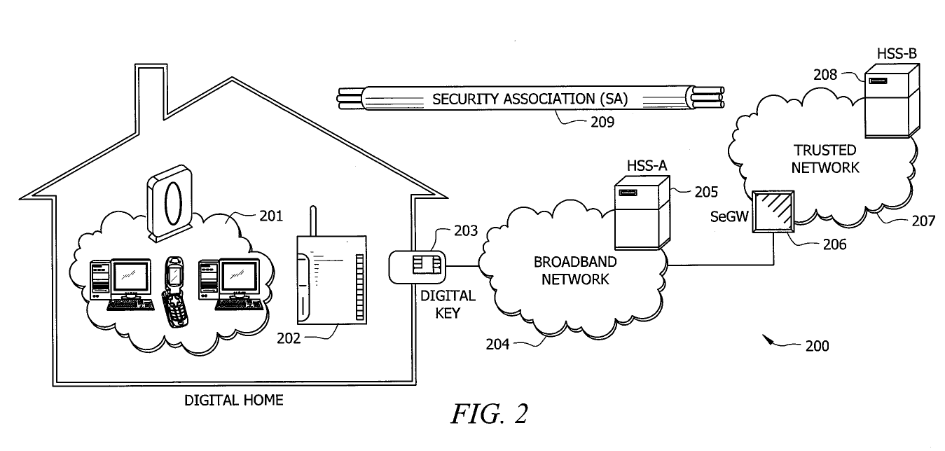

Referring now to FIG. 2, an embodiment of a system 200 for using identity associations to provide secure, trusted access between devices in a private network 201, such as a home network, and a trusted network 207, is shown. Home network 201 uses a private addressing scheme with NAT functionality provided by device 202. Home network may consist of wired network connections, such as Ethernet or cable, wireless networks such as under the IEEE 802.11 scheme, or cellular networks as provided by a cellular femtocell. Other types of networking protocols that use one or more of the previous media are also included in the types of protocols which can be utilized by the concepts described herein. Examples of these other protocols include MoCA (Multimedia over Coax Alliance), HomePNA (Home Phoneline Networking Alliance), VDSL (Very High Speed DSL), or PLC (Power Line Communication).

Device 202 provides the connection between broadband network 204 and home network 201. As described, device 202 provides the NAT functionality to interface between the private network addressing scheme of home network 201 and the public addressing scheme of broadband network 204. Device 202 can also include router and wireless and cellular access point functionality or may be connected to generic base station to provide the access point functionality. According to the concepts described herein, device 202 is also responsible for providing secure access to the home network and authenticating the end user devices in home network 201 as trusted devices.

To accomplish this, device 202 uses digital keys 203 which are incorporated into or are interfaceable with device 202. Digital keys 203 include digital security credentials and may or may not be used in conjunction with user ids and passwords for authentication. The digital keys are incorporated into a digital key interface, which can be a physically connected device which is inserted into a port on device 202, or can be connectionless such as embodiments where the digital key interface is part of an RFID or Smart Card device which is then placed in the proximity of a reader such as device 202. Digital keys 203, by establishing an identity association, may also be used in certain embodiments to implement a secure association according to the appropriate standards, such as GAA (Generic Authentication Architecture), HTTP Digest Authentication, or other similar standard. Device 202 and digital keys 203 allow for the encryption of communications to and from device 202 using IPSec or any other appropriate encryption scheme.

Digital keys 203 are, therefore, able to provide an identity association which then allows a secure explicit path, shown by security association (SA) 209, to be created. The digital keys 203 are therefore able to provide the functionality provided by a SIM card in the cellular network context. The digital keys 203 with the device 202 are able to provide a billable identity for the home, or business, or individual user in the home or business that could be used by a device in private network 201 for both communications and content delivery. The digital keys are preferably physical devices including contactless devices (e.g. smart cards, or devices using RFID type technologies) or contacted devices (e.g. devices inserted into a port on the device). Using a physical device increases the security of a connection by requiring the physical device to be present to establish the connection and is much harder to duplicate or fake than a purely digital security certificate. A home security gateway may have any number of digital keys as required by the subscriber and devices to be used.

As described, device 202 provides the interface between private network 201 and broadband network 204. Broadband network 204 includes authentication server 205 which is operable to manage the identity association through broadband network 204. Authentication server 204 can be a home subscriber server which maintains a home location registration that keeps trace of services for each subscriber similarly to the subscriber registry in a cellular network. Broadband network 204 is connected to trusted or provider network 207 through security gateway 206. Security gateway 206 provides secure termination and aggregation for user endpoints that are accessing the trusted core network. The security gateway provides IPSec Encryption, dynamic session security and real-time bandwidth management to provide security for multiple trusted connections with end user devices such as device 202. Security gateway 206 can be a security gateway or session controller as is commonly available. Security gateway 206 provides the termination of security association 209 in the core of trusted network 207. While authentication server 205 provides subscriber services for the broadband network, authentication server 208 provides similar functionality for the provider network 207. Such functionality could alternatively be provided externally by a third party, such as, for example, an application service provider (ASP). Authentication server 208 includes a registry database that keeps track of subscriber identities, allowed services and service and subscriber parameters. The functionality provided by security gateway 206 and/or the authentication server 208 create an authentication mechanism that can be used in conjunction with device 202 and digital keys 203 to establish an identity association. While the authentication mechanism of FIG. 2 has been described with reference to both the security gateway and authentication server, the function of the authentication mechanism could be performed by either one of the devices individually. Further, the security gateway or authentication server could be implemented virtually on one or more devices while still operable functionally to provide the authentication mechanism described herein.

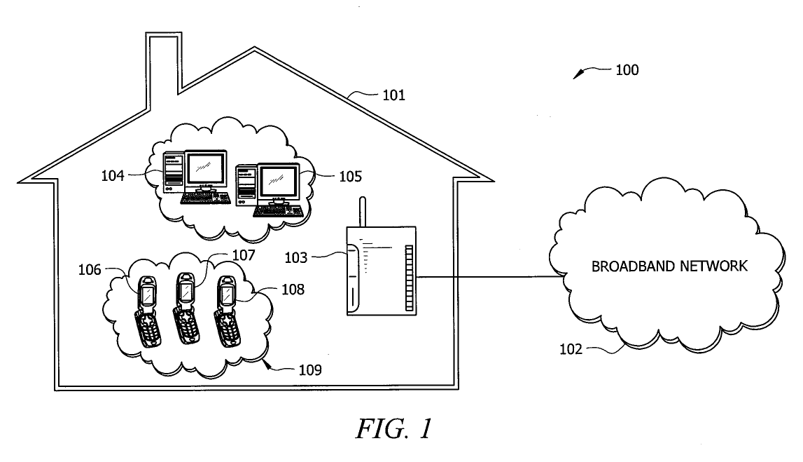

By providing a secure path 209 between private network 201 and trusted network 207, system 200 is able to provide functionality not realizable with the network shown in FIG. 1. System 200, using device 202, digital keys 203 and security gateway 206, is able to provide both secure identity and path between trusted network 207 and private network 201, thereby allowing enhanced conditional access services, or iCAS to be used by the providers. Providing iCAS functionality into the network effectively extending the reach of trusted network 207 to the end user devices in private network 201, and is also able to exert granular control over access to devices, services and content as well as allowing enhanced content detail records or iCDRs. In addition to enhanced content detail records that can be used for billing and accounting purposes the iCAS functionality allows a functional state to be maintained for content and services.

As described, different types of functionality are available based on the iCAS using the identity association. For example, in embodiments the use of iCAS can allow the user/subscriber to start and stop access to content or services and to dynamically shift the access to that content or services between devices or locations. Since the digital key is a physical token that is device independent, the user can take the digital key from one device to another or from one location to another and then have access to same content from the different device. Using the functional state maintained by the system as will be described below, the users location in the content can be stored so that the user can resume access to the content from place in the content where previous access was halted.

In lieu of providing free content to the customer, the content provider may provide pay-per-view or pay-per-use content. In such a case, iCAS would allow the broadband network provider to bill the customer for the ordered content.

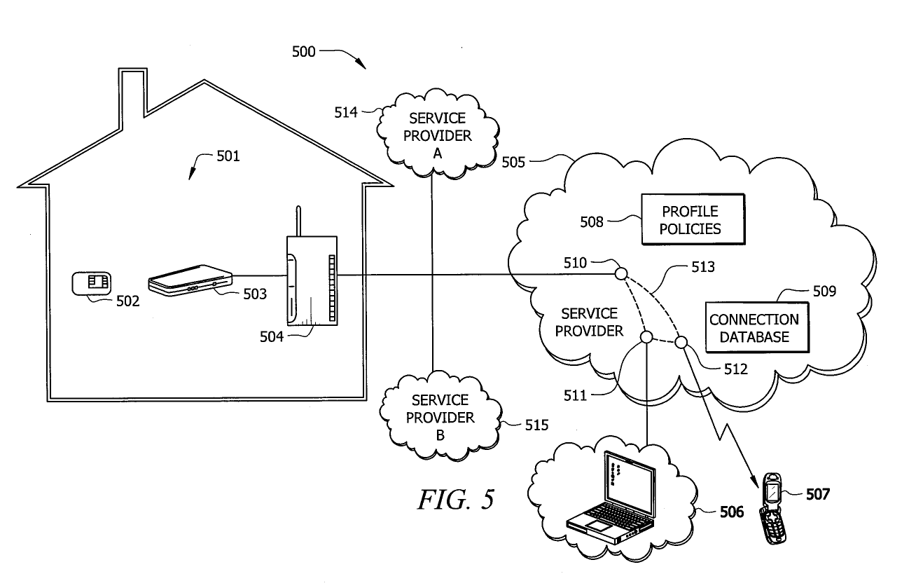

In another embodiment of the system, iCAS using the identity association would be able to extend the reach of the trusted network to the end user devices to allow content or services to follow the user as they switch between devices or network. Functional state can also be maintained, as will be described with reference to FIG. 5, to allow the user to access the content or services from points within the content or services last accessed by the user. For example, if the trusted network was a wireless provider, the existence of the identity association would allow the mobile customers to access content and devices in the private network from their mobile devices over a secure connection, or could allow data from the private network to be pushed to the mobile device upon the occurrence of a triggering event in the private network.

While particular examples have been described to illustrate the types of applications available using a system incorporating the concepts described herein, the examples are not limiting, and any type of functionality or application could be implemented that relies on the identity association, or resulting security association or billable identity or any of the other features described according to the concepts set forth herein.

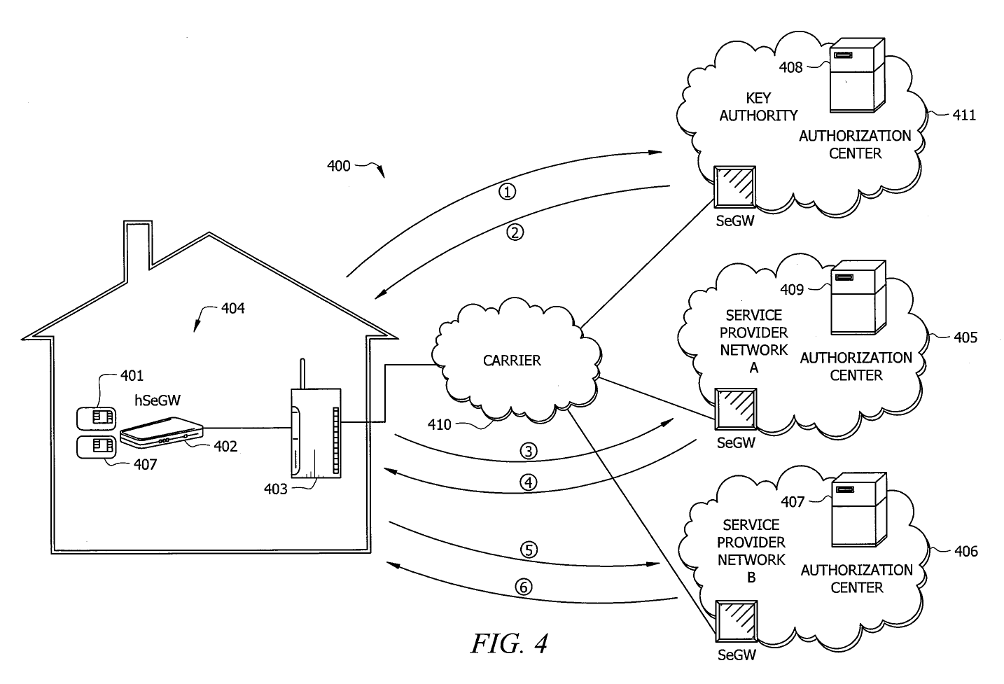

While FIG. 2 has been used to describe some of the functionality and services enabled by iCAS as described herein, embodiments of iCAS and the digital supply chain use the physical token and requires key exchanges between the user and provider. In the embodiment described in FIG. 2 the user and provider were responsible for the acquisition and management of their own keys. There are several aspects to the key management that could easily be consolidated and managed by a third party key authority who could manage the iCAS implementation and maintain and control distribution of the keys used by iCAS. In preferred implementations of iCAS, the user needs a physical token or tokens that correspond to the relationships that user has with content and service providers, such as a carrier, key authority and service and content providers. This physical token must be created and distributed to the user or to a place where the user can acquire it. Next, the attributes of each of those physical keys must be maintained in a database and updated as the key is associated with a user and the user's profile and attributes change. The key distribution and maintenance can be done by each individual provider or could be performed by a key authority that is tasked with managing the key distribution maintaining the key registries for multiple providers and their associated user's. FIGS. 4 and 5 will describe these and other embodiments in greater detail.

Another application of system 200 using device 202, which can also be referred to as a home security gateway, would be to implement and manage the iCAS relationships usable by the subscriber. As described, the digital keys can be used to create an identity association with the subscriber. As such, the home security gateway, as a single point of reference with the digital keys can be turned into a digital wallet to provide secure payment and billing relationships between the subscriber and a carrier, provider or vendor on the network. As the carrier and the subscriber have a trusted relationship with the carrier having an iCAS identity with the subscriber through the use of the digital keys, the carrier can also act as an intermediary in payment or billing relationships between the subscriber and providers, merchants or vendors. The carrier could use its billing relationship with the subscriber to bill for services, content or items purchased by the subscriber, with the vendors/providers getting a single billing point for many customers. In this manner, vendors/providers can avoid having to establish billing relationships with many individual subscribers.

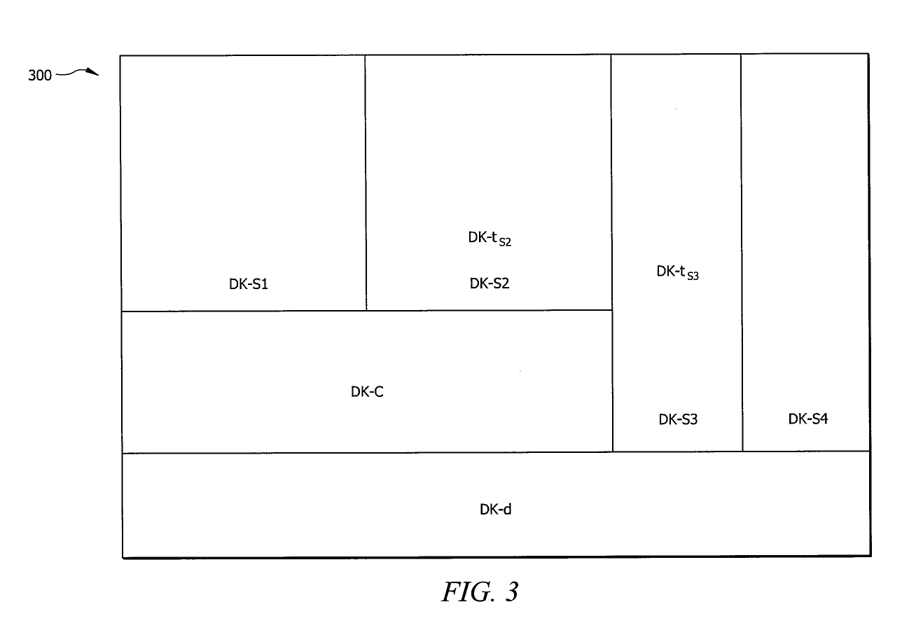

Referring now to FIG. 3, system 300 is an embodiment of a system according to the concepts described herein. Device 202 from FIG. 2 has multiple digital keys, such as digital key 203, associated with it. In the embodiment of system 300 a single device key Dk-d controls all of the identity associations and key exchanges for the device. Device key Dk-d is provided to the user, preferably along with the device itself, by a key authority or key manufacturer through any number of mechanisms. The key authority may own the device or may sell the device to the user. Once the device has been effectively enabled by the device key Dk-d, other keys may be used with the device to establish identity associations with other carriers or providers. In the example of system 300, a carrier has a relationship with the user and has its own identity association, as shown by carrier key Dk-c. Further, the user has relationships with multiple providers of content or services which are provided directly by the key authority, Dk-s3, Dk-s4, or through the relations ship with the carrier, Dk-s1, Dk-s2.

Information regarding each of the keys is preferably maintained by a key authority, though it is possible that another entity such as the carrier could maintain a subset of key information for particular providers, such as keys Dk-s1 and Dk-s2. In addition to the keys establishing the identity associations, each party having an identity association can have transactions that are controlled by separate transaction keys, such as Dk-ts2 or Dk-ts3. These transaction keys can be any type of transaction including purchases, the unlocking of secured content, pay-per-view, billing, or any other type of transaction. Each key's information is maintained by it's own logical corresponding authentication center, which may be physically hosted by one or more application service providers. Key authorities are the gate for service/content keys and service/content authentication center pairings.

An alternate embodiment of a system 300 for providing secure, trusted access between devices in private networks 301, 302, such as a home network, and a provider network 303 or trusted carrier network 304 using an access carrier network 305 or the Internet 306, is shown. System 300 operates similarly to system 200 from FIG. 2 except that the different layers of network traffic (i.e. the signaling layer and the media layer) are each potentially controlled by separate devices. Where a single device, device 202 from FIG. 2, handles both the signaling and media channels, that functionality is distributed over multiple devices in system 300.

Referring now to FIG. 4, an embodiment of a system 400 for creating and utilizing secure identity associations using a key authority is shown. Reference may be made to the keys described with respect to FIG. 3. System 400 includes device 402, which accepts digital keys 401 and 407. A portal 403, such as a DSL or cable modem, or other interface device with a carrier network 410, may used to connect device 402 to key authority 411 and to service provider networks, such as service provider A network 405 and service provider B network 406. The connection between any of the networks is for illustration only and may include any network topology and may utilize a public network.

An embodiment of a process for creating an identity association between the service provider in service provider network, and a user in private network 404 using the concepts described herein begins with the detection of digital key 401. Digital key 401 may be provided to the end user by key authority 411 who may provide the end user with device 402 and device key 401 (Dk-d). Once the digital key 401 associated with the key authority has been detected, device 402 is able to establish an identity association with the key authority by registering the device key with authentication system 408 in key authority network 405. As illustrated in FIG. 3, once the device has been registered, the user may use other keys, such as key 407 to initiate relationships with service or content providers, such as is shown by the service provider keys described in FIG. 3. Once a service provider key, such as key 407 has been detected by device 402, device 402 proceeds to authenticate the key and service provider by checking with the key authority as shown by steps 1 and 2 in FIG. 4.

Once the key authority has authenticated the service provider, such as for example, service provider A, device 402 may establish an identity association with service provider A and register with service provider A's authentication server 409, as is shown by steps 3 and 4. Other service providers may be nested off of the key authority or any existing service provider, such as is shown by service provider B and it's authentication server 407 and by steps 5 and 6. The nesting of service providers may be any number of layers deep and include any number of relationships according to the concepts described herein. As has been described, preferred embodiments require that an identity association for the device, such as is illustrated by device key 401 (Dk-d), be established with the key authority before other identity associations can be created.

As an example of the key authority's management of keys for service providers and/or carriers a transaction between provider A 405 and the user can be described. Digital key 407 is a digital key issued on behalf of the service provider by key authority 411. As described, service provider may be a provider of services, content, goods, etc. Device 402 detects the proximity of service provider digital key 407, and then sends information associated with that key to the key authority to establish the identity association with the service provider using authentication server 408. A security association, or service tunnel, is then set up between the device 402 and the service provider network 405 by registering with the service provider's authentication server 409. Once the identity association has bee established, the service provider has the secure connection that allows it to provide its contents or services to the user over a secured connection.

While the system shown in FIG. 4 shows the setting up of an identity association with where the key authority and provider are connected through a carrier which may have its own identity association, such as described by carrier key Dk-c, the service providers may be part of, nested with, or connected directly to the key authority. While particular topologies are shown with respect to FIG. 4, any topology that allows a key authority to control and manage the key distribution for providers or carriers is well within the scope of the concepts described herein.

Referring now to FIG. 5, an embodiment of a system for providing functional state for devices using identity associations and iCAS is shown. System 500 includes private network 501, which has digital key 502, device 503 and portal 504 operating as previously described. Private network connects to service provider 505 which may be a key authority, an application service provider, carrier or other network provider. User devices 506 and 507 are associated with the user of private network 501 and may be used to access private network 501, including content stored on private network 501 or may also be used to access service providers A 514 or B 515, with whom the user has a trusted relationship as described above. User devices preferably have a mechanism for reading a digital key associated with the private network, or service provider to allow then to establish an identity association according to the concepts described herein.

In order to maintain the function state for content accessed by the user across disparate devices or networks, a profile is maintained for the user either at the service provider, profile 508, or at the user's private network, profile 516. When a user device, such as device 507 accesses content that was previously being used by the user, the device checks the functional state in the profile and may then access the content from the point indicated in the functional state. The state for content from service providers may also be stored with the service provider or may be maintained in the profile in the user's private network.

User devices my also interact directly in a trusted manner. A connection database 509, which may be stored in the service provider network, or elsewhere in the network, can be used to associate devices from the same user using the techniques described herein. In that manner the secure endpoints 510, 511, 512 from the various user devices may have virtual connections 513 that allow then to interact in a trusted manner.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a device connectable to a private network and designed to access to a public network, the device used to control identity associations for end user devices in the private network, wherein the device has an associated device key and is operable to receive additional keys associated with service providers; and
a conditional access system associated with the device, the conditional access system operated by a key authority to manage the device key and to authenticate the service provider keys thereby allowing identity associations between the private network and the service providers.

2. The system of claim 1 wherein each of the keys is a physical token readable by the device.

3. The system of claim 2 wherein the device uses radio frequency identification to communicate with the physical token.

4. The system of claim 1 wherein the key authority maintains a database of keys issued for the service provider.

5. The system of claim 1 further comprising a portal connected to the device, the portal providing an interface between the private network and the public network.

6. The system of claim 1 wherein each service provider may issue transaction keys for specific transactions with the end user.

7. The system of claim 1 wherein the service keys are nested behind the device key, such that the device communicates with the key authority to authorize each service provider key.

8. A method of providing conditional access to content and services using an identity association, the method comprising:
providing a device and associated device key to an end user, the device operable to establish identity associations between the user and service providers, the identity associations used to provide conditional access to content and services;
issuing a service keys to the user on behalf of service providers to allow the service provider to establish an identity association with the user; and
authenticating at a key authority the service provider keys on behalf of the service provider to allow the service provider to initiate a identity association with the user.

9. The method of claim 8 wherein additional service provider keys by be nested behind the service provider.

10. The method of claim 8 further comprising issuing transaction keys by a service provider, the transaction key allowing a specific transaction with the user.

11. The method of claim 8 wherein the keys may be used at multiple devices.

12. The method of claim 11 wherein the keys may be used with a portable device.

13. The method of claim 8 wherein the keys are physical tokens.

14. The method of claim 13 wherein the keys communication with the device using radio frequency identification.

15. A system for allowing an end user to access content across multiple platforms, the system comprising:
a home security gateway connectable to a private network and designed to access to a public network, the home security gateway used to control identity associations for end user devices in the private network, wherein the home security gateway has an associated device key and is operable to receive additional keys associated with service providers;
a conditional access system associated with the device, the conditional access system operated by a key authority to manage the device key and to authenticate the service provider keys thereby allowing identity associations between the private network and the service providers; and
a device having access to the public network, the device able to recognize keys associated with the private network such that the device can access the private network using an identity association;
wherein a proxy in the private network is able to maintain functional state for content viewed by the end user such that the end user is able to switch content access between the private network and the device while maintaining the functional state of the content.

16. The system of claim 15 wherein each of the keys is a physical token readable by the device.

17. The system of claim 16 wherein the device uses radio frequency identification to communicate with the physical token.

18. The system of claim 15 wherein the end user may access service provider content using the proxy in the private network.

19. The system of claim 15 wherein a carrier maintains a database of connections associated with the end user and provides the end user trusted access between the end user devices.

20. The system of claim 15 wherein the proxy is maintained by the key authority instead of in the private network.
